(19) United States
(12) Patent Application Publication
(10) Pub. No.: US 2009/0027417 A1
(43) Pub. Date: Jan. 29, 2009

(54) Method and apparatus for registration and overlay of sensor imagery onto synthetic terrain

(76) Inventors: Joseph B. Horsfall, Edwardsville, IL (US); Linda J. Goyne, Florissant, MO (US); Michael F. Leib, Saint Charles, MO (US); Ken L. Bernier, O'Fallon, MO (US)

Correspondence Address: HARNESS DICKEY & PIERCE, PLC, P.O. BOX 828, BLOOMFIELD HILLS, MI, 48303, US

(21) Appl. No.: 11/880,763

(22) Filed: Jul. 24, 2007

(51) Int. Cl. G09G 5/00

(52) U.S. Cl. 345/629

(57) ABSTRACT

A method and apparatus for registering sensor imagery onto synthetic terrain is disclosed. The method comprises the steps of accepting a sensor image having sensor image data, registering the sensor image data, orthorectifying the registered sensor image data, calculating overlay data relating the registered and orthorectified sensor image data to geographical references, converting the registered and orthorectified image data into a texture, and draping the texture over synthetic terrain using the overlay data.

### CROSS REFERENCE TO RELATED APPLICATIONS

This application is related to the following U.S. patent applications, which are hereby incorporated by reference herein:

U.S. patent application Ser. No. 11/554,722 by Michael F. Leib and Lawrence A. Oldroyd for “METHOD AND SYSTEM FOR IMAGE REGISTRATION QUALITY CONFIRMATION AND IMPROVEMENT” filed Oct. 31, 2006, which application is a continuation-in-part (CIP) of U.S. application Ser. No. 10/817,476, by Lawrence A. Oldroyd, for “PROCESSING ARCHITECTURE FOR AUTOMATIC IMAGE REGISTRATION”, filed Apr. 2, 2004.

### BACKGROUND

1. Technical Field

The present disclosure relates to systems and methods for presenting sensor imagery, and in particular, to a method and apparatus for registration and overlay of sensor imagery onto synthetic terrain.

2. Description of the Related Art

Three-dimensional (3-D) terrain rendering is quickly becoming a highly desirable feature in many situational awareness applications, such as those used to allow military aircraft to identify and attack targets with precision guided weapons.

In some cases, such terrain rendering is accomplished by draping textures over 3-D synthetic terrain that is typically created from a database having data describing one or more Digital Elevation Models. Such textures might include wire-frame, checkerboard, elevation coloring, contour lines, photo-realistic, or a non-textured plain solid color.

Typically, these textures are either computer generated or are retrieved from an image database. However, the authors of this disclosure have discovered that during a mission, auxiliary sensor imagery of a given patch of terrain may become available. Such auxiliary imagery may ultimately come from synthetic aperture radar (SAR), infrared (IR) sensors and/or visible sensors), and is generally data having different metadata characteristics (e.g. different resolution, update rate, perspective, and the like). The authors have also recognized that it would be desirable to accurately, rapidly, and automatically register and overlay this imagery onto the synthetic terrain, and do so with modular software components, thus permitting this task to be performed economically.

Therefore, what is needed is a method and apparatus for the economical and rapid registration and overlay of multiple layers of textures, including textures from auxiliary sensor data over synthetic terrain. This disclosure describes a system and method that meets that need.

### SUMMARY

To address the requirements described above, this document discloses a method and apparatus for registering sensor imagery onto synthetic terrain. In one embodiment, the method comprising the steps of accepting a sensor image having sensor image data, registering the sensor image data, orthorectifying the registered sensor image data, calculating overlay data relating the registered and orthorectified sensor image data to geographical references, converting the registered and orthorectified image data into a texture, and draping the texture over synthetic terrain data using the overlay data. The apparatus comprises a first processor for accepting a sensor image having sensor image data, a second processor for registering the sensor image data, for orthorectifying the registered sensor image data, and for calculating overlay data relating the registered and orthorectified sensor image data to geographical references, and a third processor for converting the registered and orthorectified image data into a texture and for draping the texture over synthetic terrain data using the overlay data.

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

Referring now to the drawings in which like reference numbers represent corresponding parts throughout:

FIG. 1 is a drawing illustrating one embodiment of an auxiliary sensor data registration system;

FIG. 2 is a flow chart presenting illustrative method steps that can be used to register sensor imagery onto synthetic terrain;

FIG. 3 is a depiction of an auxiliary sensor image;

FIG. 4 is a depiction of a reference image;

FIG. 5 is a depiction of a composite image that is a result of the registration, orthorectification, and rotation process applied to the auxiliary sensor image shown in FIG. 3;

FIG. 6 is a diagram illustrating synthetic terrain from a digital elevation model;

FIG. 7 is a diagram showing the texture of FIG. 5 draped over a map texture;

FIG. 8 is a diagram showing an orthorectified (overhead view) of the image shown in FIG. 7; and

FIG. 9 is a diagram of an exemplary computer system that could be used to register the sensor data on the synthetic terrain.

### DETAILED DESCRIPTION OF PREFERRED EMBODIMENTS

In the following description, reference is made to the accompanying drawings which form a part hereof, and which is shown, by way of illustration, several embodiments. It is understood that other embodiments may be utilized and structural changes may be made without departing from the scope of the present disclosure.

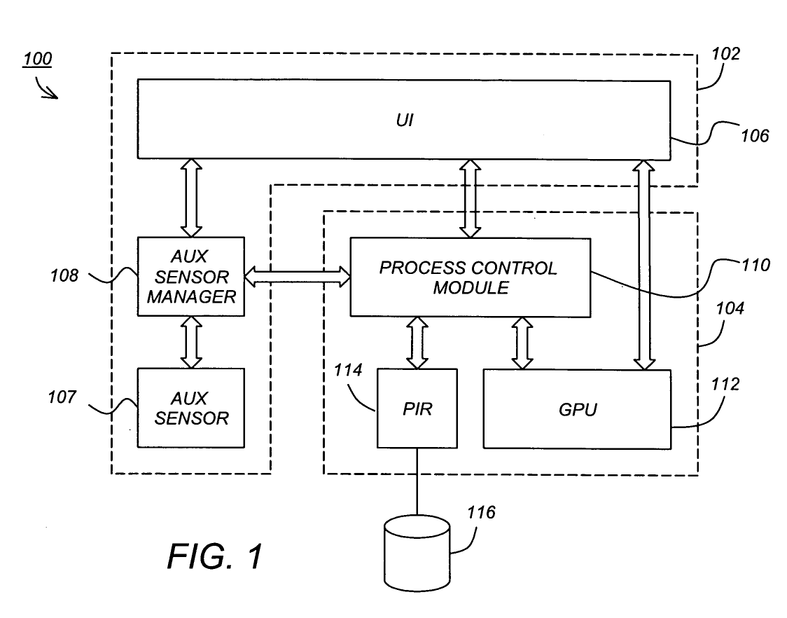

FIG. 1 is a drawing illustrating one embodiment of an auxiliary sensor data registration system (ASDRS) 100. The ASDRS comprises an image generation and simulation module 102 comprising an auxiliary sensor 107 such as a synthetic aperture radar, IR sensor, or visible light sensor, communicating with a user interface 106 via an auxiliary sensor manager 108. Under control of the auxiliary sensor manager 108, data is provided from the auxiliary sensor 107 to the UI 106 (if user interaction with the data is desired or the PCM 110 if automatic processing of the data is desired). The auxiliary sensor manager 108 may also generate and/or format metadata regarding the data from the auxiliary sensor 107 for use by the UI 106 and PCM 110. Such metadata may include, for example, pixel resolution, pixel size, bit resolution (e.g. 8-bit) and the like. The UI 106 provides an optional interface between the auxiliary sensor manager 108 and the process control module 110 to accept user input regarding registration and image processing, and to accept data to be displayed to the user from the PCM 110. The PCM 110 controls the generation of images, accepting metadata needed for the registration process from either the UI 106 or directly from the auxiliary sensor manager 108 and coordinating the operations of the PIR 114 and the GPU 112.

Auxiliary sensor coordinates, auxiliary sensor elevation, target coordinates, and the size of the area to be imaged can be accepted as an input to the sensor image registration and synthetic terrain overlay (SIRSTO) module 104. These inputs may be obtained from the user via the UI 106 or directly from an external module such as a vehicle or aircraft navigation system. The SIRSTO module 104 overlays the image data from the auxiliary sensor 107 onto synthetic terrain.

The UI 106 provides the auxiliary sensor image described by the data from the auxiliary sensor 107 and the metadata pertaining to that data and the target (approximate geolocation of the center of the image from the auxiliary sensor 107, expressed, for example, as its latitude, longitude, altitude) to the precision image registration (PIR) module 114 via the process control module (PCM) 110. The PIR 114 then obtains the appropriate reference image data from a database 116 of reference images (which represent already available images), rotates and perspective-matches the reference image to match that of the auxiliary sensor image 202, and registers the auxiliary sensor image 202.

The PIR 114 then orthorectifies the registered image and optionally rotates it to a North-up orientation. The resulting image is a composite image. The PIR 114 maintains the registration of the auxiliary sensor image during the orthorectification and rotation.

The PIR 114 also calculates overlay data including geo-coordinates of geographical references such as the northwest corner of the composite image, the elevation of the center of the composite image, and latitude and longitude resolution of the image (typically, per pixel).

The PCM 110 collects the composite image and registration data from the PIR 114 and provides it to a graphics processing unit (GPU) 112. The GPU 112 converts the registered and orthorectified image data into a texture represented by texture data, and electronically drapes the composite image onto the texture for viewing using the overlay data.

Although the image generation module 102, the PIR 114 and the GPU 112 may be implemented in a single processor, in one embodiment, the image generation module 102, the PIR 114 and the GPU 112 are each implemented by separate and distinct hardware processors in a distributed processing architecture. This functional allocation also permits the use of embedded commercial off the shelf (COTS) software and hardware. Further, because the foregoing process generates its own metadata from the received auxiliary sensor data, it can accept data from a wide variety of sources, including a synthetic aperture radar.

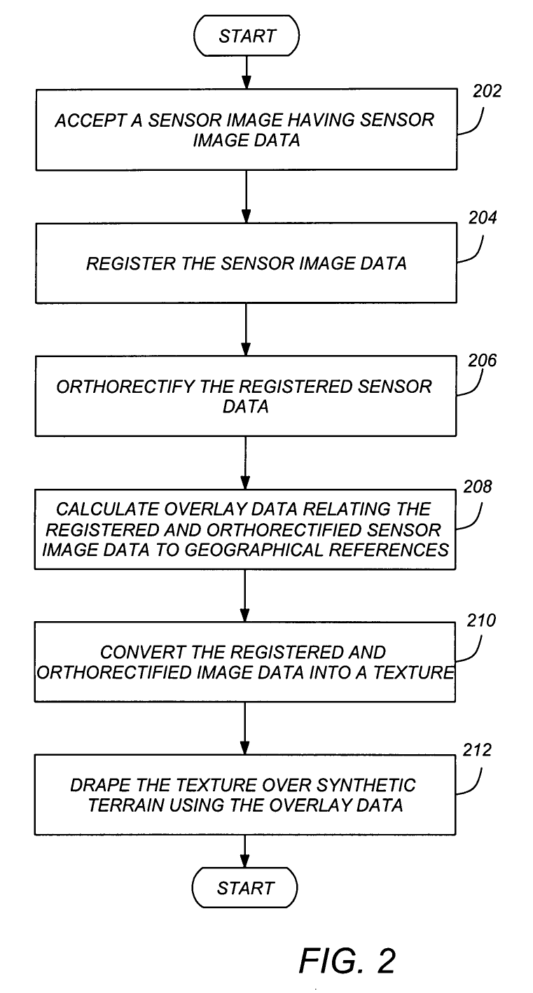

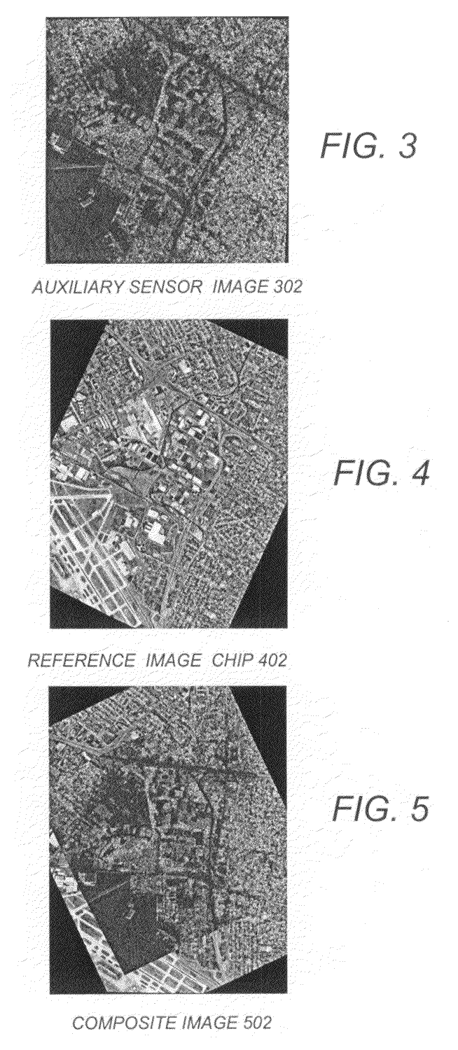

FIG. 2 is a flow chart presenting further details of the process described above. FIG. 2 will be discussed with reference to elements in FIG. 1, as well as exemplary results depicted in FIG. 3-FIG. 8 which show the result of the described image processing.

A sensor image having sensor image data is accepted, as shown in block 202. In an exemplary embodiment, the sensor image is provided by the auxiliary sensor 107 and has an appearance as shown by the auxiliary sensor image 302 of FIG. 3.

The sensor image data also includes metadata associated with the sensor image. Such metadata can include, for example (1) the number of bits per pixel, (2) the location of the sensor (which may be expressed in latitude, longitude, and elevation), (3) the approximate image center in latitude, longitude, and elevation (4) the size of the image (expressed, for example as a range and cross range, according to pixel resolution). If not provided, sensor pixel resolution may be computed and included as metadata.

In block 204, the sensor image 302 is registered. Image registration is a process by which different images of the same scene can be combined into one common coordinate system. The images may differ from one another because they were taken at different times, from different perspectives, with different equipment (e.g. photo equipment with different focal lengths or pixel sizes). Registration is necessary to provide a common reference frame by which data from different sensors or different times can be combined. The resulting (registered) image is hereinafter alternatively referred to as the “reference image” and any image to be mapped onto the reference image is referred to as the “target image”. Registration algorithms can include area-based methods or feature based methods, and can use linear transformations (translation, rotation, scaling, sheer and perspective changes) to relate the reference image and target image spaces, or elastic transformations which allow local warping of image features. Image registration can be performed by a variety of open source products including ITK, AIR, FLIRT, or COTS products such as IGROK, TOMOTHERAPY, or GENERAL ELECTRIC'S XELERIS EFLEX.

In one embodiment, the sensor (target) image is registered to an accurately geo-registered reference image using the methods described in co-pending U.S. patent application Ser. No. 10/817,476, by Lawrence A. Oldroyd, filed Apr. 2, 2004, hereby incorporated by reference herein. In summary, this process includes calculating a footprint of the auxiliary sensor 107 in Earth coordinates using an appropriate sensor model, and extracting a “chip” of a reference image corresponding to the calculated sensor footprint. A “chip” of a reference image is that port of the reference image corresponding to the “footprint” of the auxiliary sensor 107. The reference image may also comprise a plurality of adjacent “tiles” with each tile providing a portion of the reference image. This “chip” of the reference image may have a different shape than the reference image tiles, and may extend over less than one tile or over a plurality of tiles.

FIG. 4 presents an example of a reference image chip 402. A chip of a digital elevation model (DEM) corresponding to the calculated sensor footprint area is then. extracted to produce a synthetic perspective image (a reference image shifted to change perspective).

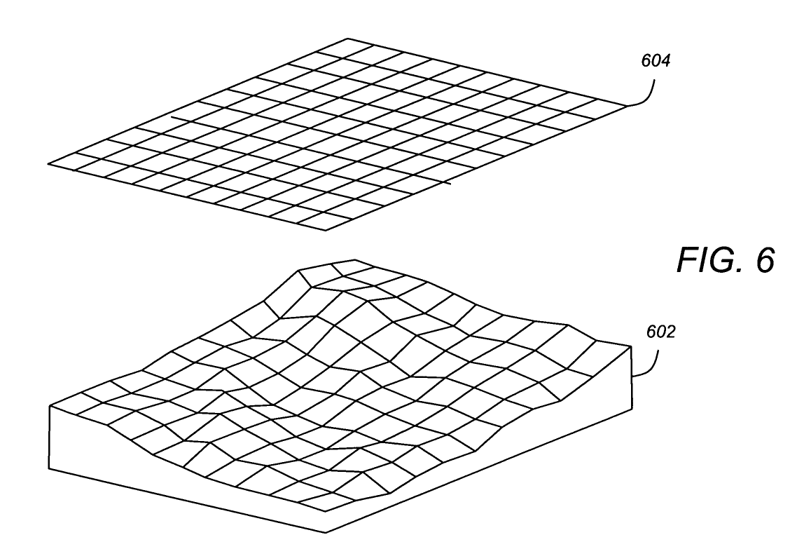

FIG. 6 is a representation showing one embodiment of synthetic terrain from a DEM 602, and its vertical projection 604.

The reference image chip 404 may then be orthorectified (e.g. reoriented so that the view is from directly above). Then, using an appropriate sensor model, a synthetic perspective image of the auxiliary sensor data is created by draping the orthorectified reference image over the DEM chip. The sensor image is then aligned with the synthetic perspective image. This results in a known relationship between the sensor and perspective images, which can then be used to associate all pixels of the sensor image to pixels in the reference image through an inverse projection of the perspective image.

As shown in block 206, the registered sensor data is then orthorectified. As described in co-pending U.S. patent application Ser. No. 11/554,722 by Michael F. Leib and Lawrence A. Oldroyd for “METHOD AND SYSTEM FOR IMAGE REGISTRATION QUALITY CONFIRMATION AND IMPROVEMENT” filed Oct. 31, 2006, which application is a continuation-in-part (CIP) of U.S. application Ser. No. 10/817,476, by Lawrence A. Oldroyd, for “PROCESSING ARCHITECTURE FOR AUTOMATIC IMAGE REGISTRATION”, filed Apr. 2, 2004, which are hereby incorporated by reference herein, this may be accomplished by creating a blank image space with the same dimensions and associated geopositions as the reference image chip created above, and for each pixel in this blank image space, finding the associated reference chip image pixel. This is a 1-1 mapping, because the images are of the same dimension and associated geopositions. Using the registration established above, the associated sensor image pixel value is found and this pixel value is placed in the (no longer) blank image space.

While the foregoing describes a system wherein a sensor image is registered then orthorectified, it is also possible to achieve the same result by orthorectifying the sensor image and registering the orthorectified sensor image to an orthorectified reference image.

If desired, the orthorectified registered sensor data can be rotated to a different reference frame. This might be needed for purposes of computational efficiency (e.g. so that the orthorectified and registered sensor data is presented in the same orientation as the synthetic terrain is going to be mapped to), or because the module that overlays the orthorectified and registered image on the synthetic terrain requires the data to be provided in a particular reference frame.

FIG. 5 presents an image showing an exemplary composite image 502 that is a result of the registration, orthorectification, and rotation processes applied to the auxiliary sensor data shown in FIG. 3, as described above.

Next, overlay data that relates the registered and orthorectified sensor image data to geographical references is computed. This is shown in block 208. This overlay data may comprise, for example, the number of pixel columns and rows in the registered image, geographical references such as the latitude and longitude of a location in the registered and orthorectified image (e.g. the northwest corner), the elevation of the center of the registered image, the latitude and longitude of the pixel step sizes, or important geographical landmarks (e.g. the locations of peaks or other geographically significant features).

In one embodiment, the operations shown in blocks 204-208 are performed by the PIR 114 shown in FIG. 1, and the data derived therefrom is provided to the PCM 110, which formats and routes the data to the GPU 112, where the registered and orthorectified images are converted to textures (pixel data that can be overlaid on a synthetic terrain such as polygons and other surfaces) as described below.

Next, the registered and orthorectified image data is converted into a texture, as shown in block 210. This may be performed, for example, by the GPU 112. In one embodiment, the sensor images are converted into textures by defining a transparent texture sized to fit the registered and orthorectified sensor image data, copying the registered and orthorectified image data to the transparent texture to create an imaged texture and georegistering the imaged texture. The transparent texture may be any size, but will typically be dimensioned as 2ⁿ by 2^{m}. This may create problems, as the images themselves are often not 2ⁿ by 2^{m} in dimension. To account for this, transparent “padding” may be used in the texture. For example, if the dimension of the transparent image is 1024×1024 pixels and the registered and orthorectified image is 700×500, the orthorectified image may be copied into a corner of the transparent image and the remaining pixels set to a black or a transparent value. Since it is the texture, not the image itself, that is draped into the terrain surface, the geographical coordinate data provided with the image may be adjusted to relate to the texture, so that the image will scale properly with the terrain surface.

Alternatively, a transparent texture large enough to cover all of the rendered terrain can be created, and all viewable images can then be copied to this single texture. This eliminates the need to adjust the corners of each image and eliminates the “holes” caused by draping padded images on top of one another. It also allows the display of any number of images at one time. In this embodiment, a plurality of sensor images are accepted, each having sensor data. The sensor data from each of the sensor images is registered, and orthorectified. The conversion of the registered and orthorectified image data into a texture then involves the defining of a single transparent texture that is sized to cover all of the sensor images to be rendered, including more than one of the plurality of sensor images. The registered and orthorectified image data from all of these images to be rendered then are copied to the transparent texture.

The number of textures that can be processed is typically limited by the amount of texture memory available in the graphics card implementing the rendering of the textures. The technique of converting the sensor images to a single large texture ameliorates this problem by allowing any number of sensor images to be added. Creating one large texture manages the amount of texture memory allocated without restricting the number of images that can be overlaid. Any images that are fully or partially contained within the texture's geographic area may be displayed.

Finally, as shown in block 212, the texture is electronically draped over the synthetic terrain using the overlay data. The result is an image in which the texture data is presented with the elevation information available from the synthetic terrain and in the context of the surrounding terrain.

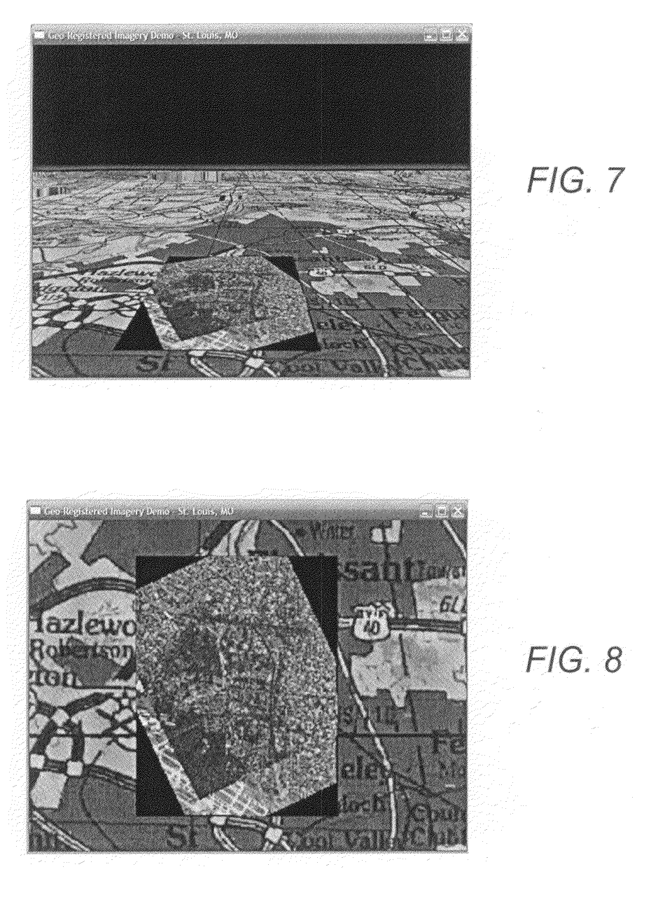

If there are multiple sensor images to be draped over the synthetic terrain, the images in question are then prioritized relative to the existing images presented on the display and the current viewpoint or perspective of the display. For example, in the case of overlapping images, older images can be draped on the synthetic terrain, with subsequent newer images draped over the older images. To increase the performance of the image presentation, the system can be configured to process only the images visible in the current view. FIG. 7 is a diagram showing the texture of FIG. 5 draped over a map texture comprising a road map of the St. Louis vicinity. Similar map textures can be used as defaults where no other information is available. FIG. 8 is a diagram showing an orthorectified (overhead view) of FIG. 7, showing the relative placement of the different textures.

As described above, the functional allocation between the PCM 110, UI 106, PIR 114, and GPU 112 is such that the PCM 110 acts as a bridge between the UI 106 (in embodiments implemented with user interaction) or the auxiliary sensor manager 108 (in automatic embodiments) and the PIR 114 and GPU 112. The PCM 110 also manages the activities of and passes data between the PIR 114 and the GPU 112.

In one embodiment, the functional allocation of the operations discussed above and illustrated in FIG. 2 between the elements shown in FIG. 1 are such that the auxiliary sensor manager 108 accepts the sensor image data (block 202), and passes the sensor image data directly to the PCM 110. The PCM 110 formats the sensor data for use by the PIR 114, and forwards the data to the PIR, where the operations shown in blocks 204-208 are performed. The result of these operations (registered and orthorectified image data) are provided to the PCM 110, which provides this data to the GPU 112. The GPU 112 then converts the registered and orthorectified image data into a texture and drapes the texture over the synthetic terrain using the overlay data (blocks 210-212). In one embodiment, the auxiliary sensor manager 108, the PIR 114, and the GPU 112 are implemented in separate processors (e.g. the functions of the auxiliary sensor manager 108 are performed in an auxiliary sensor manager processor, the functions of the PIR 114 is performed by the PIR processor, and the functions of the GPU 112 are performed by a GPU processor). This allocation of functionality permits the rapid registration of sensor imagery onto synthetic terrain.

However, other functional allocations of the operations shown in FIG. 2 and the elements shown in FIG. 1 are possible. Further the GPU 112 itself may be implemented by a separate terrain engine software module.

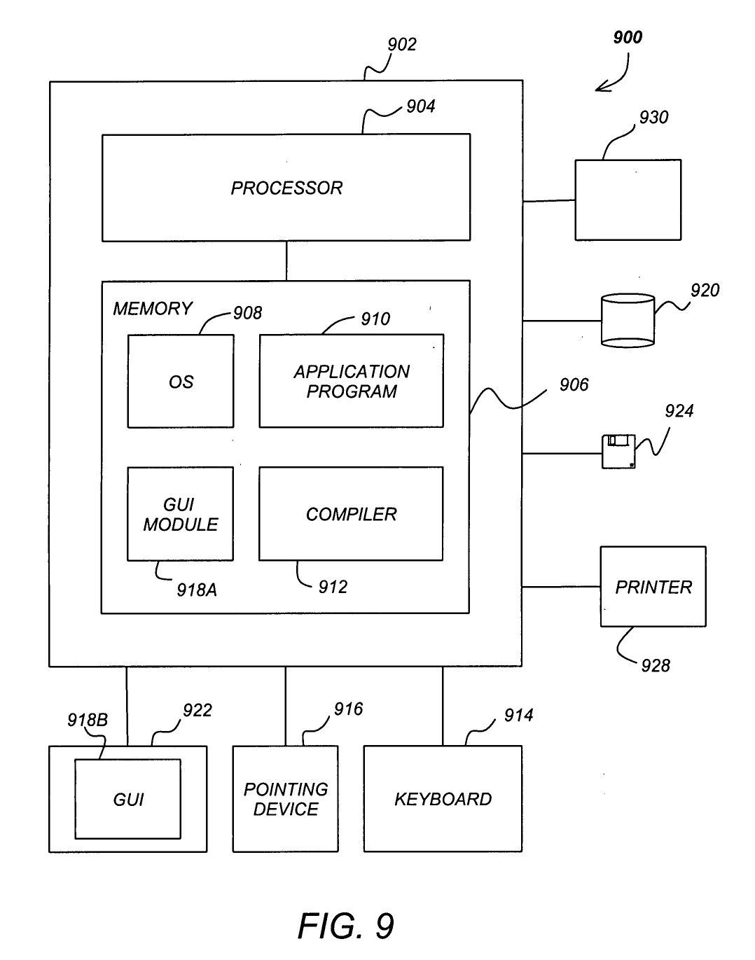

FIG. 9 is a diagram of an exemplary computer system 900 that could be used to implement the elements described above. The computer system 900 comprises a computer 902 that includes a processor 904 and a memory, such as random access memory (RAM) 906. The computer 902 is operatively coupled to a display 922, which presents images such as windows to the user on a graphical user interface 918B. The computer 902 may be coupled to other devices, such as a keyboard 914, a mouse device 916, a printer, etc. Of course, those skilled in the art will recognize that any combination of the above components, or any number of different components, peripherals, and other devices, may be used with the computer 902.

Generally, the computer 902 operates under control of an operating system 908 stored in the memory 906, and interfaces with the user to accept inputs and commands and to present results through a graphical user interface (GUI) module 918A. Although the GUI module 918A is depicted as a separate module, the instructions performing the GUI functions can be resident or distributed in the operating system 908, the computer program 910, or implemented with special purpose memory and processors. The computer 902 also implements a compiler 912 which allows an application program 910 written in a programming language such as COBOL, C++, FORTRAN, or other language to be translated into processor 904 readable code. After completion, the application 910 accesses and manipulates data stored in the memory 906 of the computer 902 using the relationships and logic that was generated using the compiler 912. The computer 902 also optionally comprises an external communication device such as a modem, satellite link, Ethernet card, or other device for communicating with other computers.

In one embodiment, instructions implementing the operating system 908, the computer program 910, and the compiler 912 are tangibly embodied in a computer-readable medium, e.g., data storage device 920, which could include one or more fixed or removable data storage devices, such as a zip drive, floppy disc drive 924, hard drive, CD-ROM drive, tape drive, etc. Further, the operating system 908 and the computer program 910 are comprised of instructions which, when read and executed by the computer 902, cause the computer 902 to perform the steps necessary to implement the method steps described above. Computer program 910 and/or operating instructions may also be tangibly embodied in memory 906 and/or data communications devices 930, thereby making a computer program product or article of manufacture. As such, the terms “article of manufacture,” “program storage device” and “computer program product” as used herein are intended to encompass a computer program accessible from any computer readable device or media.

Those skilled in the art will recognize that many modifications may be made to this configuration without departing from the scope of the present disclosure. For example, those skilled in the art will recognize that any combination of the above components, or any number of different components, peripherals, and other devices, may be used.

### CONCLUSION

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto. The above specification, examples and data provide a complete description of the manufacture and use of the system and method.

What is claimed is:

1. A computer implemented method of registering sensor imagery onto synthetic terrain, comprising the steps of:
(a) accepting a sensor image having sensor image data;
(b) registering the sensor image data;
(c) orthorectifying the registered sensor image data;
(d) calculating overlay data relating the registered and orthorectified sensor image data to geographical references;
(e) converting the registered and orthorectified image data into a texture; and
(f) electronically draping the texture over synthetic terrain using the overlay data to provide a three dimensional terrain rendering.

2. The method of claim 1, wherein step (a) is performed in a sensor manager module by a first processor, steps (b), (c), and (d) are performed in an image registration module by a second processor, and steps (e) and (f) are performed in a graphics processing unit by a third processor.

3. The method of claim 2, wherein the sensor image data includes the image and image metadata, including the location of the sensor generating the sensor image data.

4. The method of claim 2, further comprising the step of generating metadata from the sensor image, and wherein the registered sensor data is orthorectified, and the overlay data is calculated using the generated metadata.

5. The method of claim 1, further comprising the step of rotating the registered and orthorectified image data calculated in step (d) to a North-up orientation before converting the registered and orthorectified image data into a texture in step (e).

6. The method of claim 5, wherein the step of converting the registered and orthorectified image data into a texture comprises the steps of:
defining a transparent texture sized to the registered and orthorectified sensor image data;
copying the registered and orthorectified image data to the transparent texture to create an imaged texture; and
georegistering the imaged texture.

7. The method of claim 1, wherein the geographical references include:
a latitude and longitude of a corner of the registered and orthorectified image; and
an elevation of a center of the registered and orthorectified image.

8. The method of claim 1, wherein the sensor image data is provided by a synthetic aperture radar (SAR).

9. The method of claim 1, wherein:
the step of accepting sensor image data comprises the step of accepting a plurality of sensor images, each having sensor image data;
the step of registering the sensor image data comprises the step of registering the sensor image data from each of the sensor images;
the step of orthorectifying the registered sensor image data comprises the step of orthorectifying the registered sensor image data for each of the sensor images;
the step of calculating overlay data relating the registered and orthorectified sensor image data to geographical references comprises the step of calculating overlay data relating the registered and orthorectified sensor image data to geographical references for each of the sensor images; and
the step of converting the registered and orthorectified image data into a texture comprises the steps of:
defining a transparent texture sized to cover all of sensor images to be rendered, including more than one of the plurality sensor images; and
copying the registered and orthorectified image data from all of the sensor images to be rendered to the transparent texture.

10. An apparatus for registering sensor imagery onto synthetic terrain, comprising:
a sensor manager module, implemented by a first processor for accepting a sensor image having sensor image data;
an image registration module, implemented by a second processor for registering the sensor image data, for orthorectifying the registered sensor image data, and for calculating overlay data relating the registered and orthorectified sensor image data to geographical references; and
a graphics processing module, implemented by a third processor for converting the registered and orthorectified image data into a texture and for draping the texture over synthetic terrain using the overlay data.

11. The apparatus of claim 10, wherein the sensor image data includes the image and image metadata, including the location of the sensor generating the sensor image data.

12. The apparatus of claim 10, wherein the first processor generates metadata from the sensor image and the second processor orthorectifies the registered sensor image data, and calculates the overlay data relating the registered and orthorectified sensor image data to geographical references using the generated metadata.

13. The apparatus of claim 10, wherein the second processor further rotates the registered and orthorectified image data calculated in step (d) to a North-up orientation before converting the registered and orthorectified image data into a texture.

14. The apparatus of claim 13, wherein the third processor converts the registered and orthorectified image data into a texture by defining a transparent texture sized to the registered and orthorectified sensor image data, copying the registered and orthorectified image data to the texture to create an imaged texture, and georegistering the imaged texture.

15. The apparatus of claim 10, wherein the geographical references include:
a latitude and longitude of a corner of the registered and orthorectified image; and
an elevation of a center of the registered and orthorectified image.

16. The apparatus of claim 10, wherein the sensor image data is provided by a synthetic aperture radar (SAR).

17. The apparatus of claim 10, wherein:
the first processor accepts a plurality of sensor images, each having sensor image data;
the second processor registers the sensor image data from each of the sensor images, orthorectifies the registered sensor image data for each of the sensor images, and calculates overlay data relating the registered and orthorectified sensor image data to geographical references for each of the sensor images; and
the third processor converts the registered and orthorectified image data into a texture by defining a transparent texture sized to cover all of sensor images to be rendered including more than one of the plurality sensor images, and copying the registered and orthorectified image data from all of the sensor images to be rendered to the transparent texture.

18. An apparatus for registering sensor imagery onto synthetic terrain, comprising:
first means for accepting a sensor image having sensor image data;
second means for registering the sensor image data, for orthorectifying the registered sensor image data, and for calculating overlay data relating the registered and orthorectified sensor image data to geographical references;
third means for converting the registered and orthorectified image data into a texture, and for draping the texture over synthetic terrain using the overlay data; and
wherein the first means, the second means, and the third means are separate and independent processors.

19. The apparatus of claim 18, wherein the sensor image data includes the image and image metadata, including the location of the sensor generating the sensor image data.

20. The apparatus of claim 18, wherein the second means further comprises means for rotating the registered and orthorectified image data to a North-up orientation before converting the registered and orthorectified image data into a texture.

21. The apparatus of claim 20, wherein the means for converting the registered and orthorectified image data into a texture comprises:
means for defining a transparent texture sized to the registered and orthorectified sensor image data;
means for copying the registered and orthorectified image data to the texture to create an imaged texture; and
means for georegistering the imaged texture.

22. The apparatus of claim 21, wherein the geographical references include:
a latitude and longitude of a corner of the registered and orthorectified image; and
an elevation of a center of the registered and orthorectified image.

23. The apparatus of claim 18, wherein the sensor image data is provided by a synthetic aperture radar (SAR).

24. The apparatus of claim 18, wherein:
the means for accepting sensor image data comprises means for accepting a plurality of sensor images, each having sensor image data;
the means for registering the sensor image data comprises means for registering the sensor image data from each of the sensor images;
the means for orthorectifying the registered sensor image data comprises means for orthorectifying the registered sensor image data for each of the sensor images;
the means for calculating overlay data relating the registered and orthorectified sensor image data to geographical references comprises means for calculating overlay data relating the registered and orthorectified sensor image data to geographical references for each of the sensor images; and
the means for converting the registered and orthorectified image data into a texture comprises:
means for defining a transparent texture sized to cover all of sensor images to be rendered, including more than one of the plurality sensor images; and
means for copying the registered and orthorectified image data from all of the sensor images to be rendered to the texture.
